(19) United States
(12) Patent Application Publication
(10) Pub. No.: US 2020/0403481 A1
(43) Pub. Date: Dec. 24, 2020

(54) ELECTROMECHANICAL SYSTEM AS WELL AS SUPERIMPOSED GEARING FOR TRANSFERRING ROTATIONAL ENERGY

(71) Applicant: Powertrans S.A., Mondorf-les-Bains (LU)

(72) Inventor: Jörg RECKTENWALD, Merzig (DE)

(21) Appl. No.: 16/954,900

(22) PCT Filed: Dec. 20, 2018
(86) PCT No.: PCT/EP2018/086360

§ 371 Date: Jun. 17, 2020

(30) Foreign Application Priority Data
Dec. 21, 2017 (DE) 10 2017 130 880.6

(51) Int. Cl. H02K 7/116; F16H 1/28; F16H 57/02; F16H 37/04; F16H 57/04; H02K 11/33; H02K 21/14

(52) U.S. Cl. CPC H02K 7/116; F16H 1/28; F16H 57/02; F16H 37/041; F16H 2057/02078; H02K 11/33; H02K 21/14; F16H 2057/02034; F16H 2057/02069; F16H 57/0486

(57) ABSTRACT

An electromechanical system transfers rotational energy, torque and power in a powertrain coupled with a first, a second and a third machine for energy conversion (2, 3, 4). A superimposed gearing (1) includes a planetary gearbox (7) with a sun gear (8), coupled by a first shaft (5) transferring a torque to the first machine (2), and a planetary gear (9) coupled by a second shaft (6) transferring a torque to the second machine (3). The third machine (4) is configured as a three-phase synchronous machine. An internal gear (10) of the planetary gearbox (7) forms a rotor of the three-phase synchronous machine (4). The internal gear (10) is connected to a housing (15) of the planetary gearbox (7), and permanent magnets (11), exciting the three-phase synchronous machine, are arranged on the internal gear (10) and/or on the housing (15) of the planetary gearbox (7).

### CROSS REFERENCE TO RELATED APPLICATIONS

This application is a United States National Phase Application of International Application PCT/EP2018/086360, filed Dec. 20, 2018, and claims the benefit of priority under 35 U.S.C. § 119 of German Application 10 2017 130 880.6, filed Dec. 21, 2017, the entire contents of which are incorporated herein by reference.

### TECHNICAL FIELD

The present invention pertains to an electromechanical system for the especially variable-speed transfer of rotational energy, torque and power as well as to a superimposed gearing for such a system according to the independent claims. The system described has a plurality of machines for energy conversion, which are coupled to a powertrain. The individual machines for energy conversion may be operated as a motor or as a generator, and the speeds of the drive or power take-off shafts, to which the individual machines are coupled, vary. The electromechanical system has a powertrain with at least a first, a second and a third machine for energy conversion, which machines are coupled to the powertrain, and a superimposed gearing, which has a planetary gearbox, whose sun gear is coupled via a first shaft for transferring a torque to the first machine and whose at least one planetary gear is coupled via a second shaft for transferring a torque to the second machine, wherein the third machine is configured as a three-phase synchronous machine, and an internal gear of the planetary gearbox forms a rotor of the three-phase synchronous machine.

### TECHNICAL BACKGROUND

Such an electromechanical system, which uses a three-phase synchronous machine in a differential gear for wind power plants, is known from AT 507 395 A2.

Units that have different machines for energy conversion, for example, generators, internal combustion engines or turbo-engines, which are coupled mechanically to one another, are generally known. Superimposed gearings, with which the torque introduced or taken off from the different machines can be regulated in a variable-speed manner, are often provided in such units. As a rule, a planetary gear system or planetary gearbox is the essential component of the superimposed gearing used. A planetary gearbox has a centrally arranged, externally toothed sun gear, which is connected to a central shaft, at least one planetary gear meshing with the sun gear, as well as an internal gear, which meshes with the at least one planetary gear, and with respect to which the at least one planetary gear performs a relative movement.

Superimposed gearings are used in many cases in order to ensure an at least approximately constant speed on the main power take-off shaft despite a varying speed of the main drive shaft on the main drive side. Corresponding technical solutions are needed, for example, for wind power plants in order to compensate the fluctuations in the speed of the wind rotor, which are caused by fluctuations in the force of the wind and thus to protect, on the one hand, the powertrain of the wind power plant from abruptly occurring load peaks and, on the other hand, to make possible an effective operation of the generator. DE 103 14 757 B3 describes in this connection a powertrain for transferring a variable power with variable input speed and with an essentially constant output speed. A superimposed gearing is proposed, which is configured as a planetary gearbox and is coupled to a hydrodynamic torque converter in order to convert the varying speed of the rotor into a constant speed of the drive shaft of a synchronous generator. The superimposed gearing is arranged in the powertrain of the wind turbine between the main gearing and the synchronous generator. The power take-off shaft of the wind rotor is connected to the planetary gears, the sun gear is connected via the pump wheel of the torque converter to the generator shaft and the internal gear is connected to the turbine wheel of the torque converter. The braking effect of the torque converter is changed by means of specifically adjustable guide blades. The drawback of the technical solution described is, on the one hand, that torque converters have a comparatively complicated configuration and, on the other hand, that due to the hydraulic slip occurring due to the nature of the system, high losses occur precisely in the partial load range, which is significant for the economy of a wind power plant.

The use of an electrically regulated superimposed gearing, likewise configured as a planetary gearbox, for the variable-speed operation of wind power plants is also known from the article “Variable-speed Wind Power Plants with Electrically Regulated Superimposed Gearing” by P. Caselitz et al., Conference Proceedings Volume “DEWEK '92,” pp. 171-175. The technical solution described is based on the fact that the speed variability, i.e., the specific change made in the speed ratio between the rotor and the generator of the wind energy plant, is established in the mechanical part of the unit rather than in the electrical part. The shaft connected to the internal gear of the planetary gearbox is driven to this end as needed by means of a power converter-supplied asynchronous machine with cage rotor.

### SUMMARY

Based on the technical solutions known from the state of the art for the speed variation in powertrains, which have different machines which take up or release rotational energy for energy conversion, a basic object of the present invention is to propose a system that has a comparatively simple configuration, is robust and minimizes dynamic loads of the powertrain. The system shall further be suitable for advantageous use in different technical areas for making possible both an effective operation as a generator and operation as a motor. Furthermore, the supply of electrical energy into a power grid shall be possible as effectively as possible and largely without the use of complicated electronic systems and other regulation technologies.

The above object is accomplished with an electromechanical system for transferring rotational energy according to claim 1 as well as with a superimposed gearing according to claim 12. Advantageous embodiments of the present invention are the subject of the dependent claims and will be explained in more detail below partly with reference to the figures.

The present invention pertains to an electromechanical system for transferring rotational energy, torque and power in a powertrain with at least a first, a second and a third machine for energy conversion, which machine is coupled to the powertrain, and with a superimposed gearing, which is configured as a planetary gearbox and is in functional connection with the three machines. The sun gear of the planetary gearbox is coupled via a first shaft for transferring a torque to the first machine and at least one planetary gear is coupled via a second shaft for transferring a torque to the second machine. The third machine is configured as a three-phase synchronous machine. An internal gear of the planetary gearbox forms a rotor of the three-phase synchronous machine, which will be called synchronous machine for better readability in the following description. The present invention is characterized in that the internal gear is connected to a housing of the planetary gearbox, and that permanent magnets are arranged at, especially fastened to the internal gear and/or at the housing of the planetary gearbox for exciting the three-phase synchronous machine.

The synchronous machine is operated as a motor or as a generator, depending on the particular operating state, so that a braking torque or an acceleration torque is introduced into the internal gear of the planetary gearbox as needed. The suitable actuation of the synchronous machine is advantageously carried out by means of a drive electronic unit, which generates a control signal on the basis of the particular operating situation, i.e., especially by taking into consideration the speeds of the sun gear and/or of the at least one planetary gear or the shafts coupled to these gears. If, for example, the speed of the shaft is too low on the main drive side of the planetary gearbox with respect to the speed necessary on the main power take-off side, the synchronous machine can introduce a suitable acceleration torque into the internal gear. It is likewise conceivable that the internal gear is fixed in its position by the synchronous machine or even that the internal gear is rotated in the opposite direction. It is conceivable, in principle, that the planetary gearbox has a one-stage or multistage configuration. Further, the planetary gearbox may be coupled to another gearing, for example, to a main drive gearing of a wind power plant or to a stepup gearing of a processing machine or of a machine tool.

According to a special embodiment of the present invention, the third machine is configured as a permanent magnet-excited synchronous machine and the rotatably mounted internal gear of the planetary gearbox is in functional connection with the permanent magnet for exciting the synchronous machine. The permanent magnet-excited synchronous machine is preferably a higher-poled synchronous machine, which has more than two, especially four poles.

It is conceivable, in general, that the internal gear itself forms the rotor of the synchronous machine and the permanent magnets are arranged at, especially fastened to the internal gear directly. Provisions are, however, preferably made for the internal gear to be connected to the housing of the planetary gearbox and for the permanent magnets to be arranged at and especially fastened to the internal gear and/or to the housing.

In another embodiment of the present invention, the synchronous machine is controlled by a drive electronic system for controlling the energy conversion brought about in the synchronous machine. Energy conversion is defined in this connection above all as the conversion of electrical energy into rotational energy during the operation as a motor as well as of rotational energy into electrical energy during operation as a generator. A drive electronic system that is configured such that the energy conversion takes place in the synchronous machine at least at times as a function of the energy converted by the first and/or second machines and of the power released or taken up by these machines is advantageously provided.

It is also conceivable with reference to the first as well as the second machine for energy conversion that the machines are operated either as a generator or as a motor. The superimposed gearing configured as a planetary gearbox according to the present invention is connected here to a main drive shaft and to a main power take-off shaft of a powertrain, the main drive shaft and the main power take-off shaft being each either the central shaft connected to the sun gear or the planet carrier connected to the at least one planetary gear via the carrier. It is possible in this manner that a motor or generator is connected to the sun gear directly or indirectly via a drive shaft or in case of operation as a generator via a power take-off shaft. The at least one planetary gear or the planetary gears, of which there preferably are a plurality, is or are connected to the planet carrier, which forms directly the power take-off shaft or is connected to at least one other power take-off stage in case of operation as a motor. The power flow is reversed in case of operation as a generator and the planet carrier is driven directly or indirectly and it transfers a torque, rotational energy as well as a power to the at least one planetary gear.

It is also especially advantageous for the overall system, especially for the efficiency and for the minimization of electrical losses that the drive electronic system is configured such that the synchronous machine is operated at least at times in the four-quadrant operation. Furthermore, provisions are made in a special variant of the present invention for the drive electronic system to be configured such that an air gap torque of the synchronous machine can be changed depending on the power provided or taken up by the first and/or second machines. It is possible by means of a correspondingly provided adjusting device to vary the magnetic flux between the stator and the rotor and the power uptake or the power drain of the rotor of the synchronous machine coupled to the internal gear of the planetary gearbox in a specific manner.

In an especially preferred manner, the planetary gearbox is arranged in a common oil chamber with at least one other gearing. It is conceivable in this connection that the additional gearing is coupled to the planetary gearbox and is arranged between the planetary gearbox and the first or second machine, and these two gearings are arranged in a common oil chamber, i.e., in a housing sealed in an oil-tight manner to the outside. On the one hand, an especially compact arrangement of the planetary gearbox and of at least one additional gearing is possible in this manner, and, on the other hand, the number of sealing surfaces provided in the overall system or the overall powertrain and hence the number of seals and maintenance points are minimized.

Provisions are made according to another embodiment of the present invention for the first or the second machine to be configured as a three-phase asynchronous machine connected to a power supply. It is advantageous in this connection if the first or the second machine is connected to a power grid. The three-phase asynchronous machine provided here may operate both as a motor and as a generator. It is thus conceivable, for example, that a three-phase asynchronous generator converts the power delivered by a wind rotor or by a wind turbine with variable speed into electrical energy and feeds it into the connected power grid. It is essential for the powertrain configured according to the present invention in this connection that despite the changes in speed on the drive side, i.e., on the side of the powertrain, on which the wind rotor is located, the generator shaft located on the output side and hence on the generator side rotates at an at least approximately constant speed.

It is also possible, however, to use an independently excited or permanent magnet-excited synchronous machine as the first or second machine. The generator shaft must be synchronous with the power grid frequency based on the number of pole pairs in this case.

According to an alternative embodiment of the present invention, the first machine is a three-phase asynchronous motor, which drives a machine tool or a processing machine, especially in mining, via a powertrain with the superimposed gearing configured according to the present invention. Load changes on the processing machine side, which are caused, for example, by changes in the loads on the tool, are advantageously introduced in this case via the superimposed gearing and especially the internal gear into the synchronous machine coupled to this. Moreover, a smooth and controlled start of a processing machine can be achieved by the power being released into the powertrain at the start of the asynchronous motor being converted into electrical energy, which is again released into the connected grid, in a controlled manner via the synchronous machine driven by the movement of the internal gear, which synchronous machine operates in this case as a generator.

In order to make it possible to use a powertrain configured according to the present invention in areas with explosion or firedamp hazard, the individual components of the system, such as the motor, the frequency converter and the permanent magnet-excited synchronous machine, are configured as explosion-proof or flameproof components.

Provisions are made in other embodiments of the present invention for the first or the second machine to be configured as an internal combustion engine or turbo-engine, for example, as a gas turbine. It is essential in any case that a torque or a power is coupled into the powertrain or is taken up by the powertrain via the first and/or the second machine. It is conceivable in this connection to use the electromechanical system configured according to the present invention with a superimposed gearing for transferring rotational energy, torque and power for a vehicle powertrain, especially the powertrain of a vehicle with hybrid drive. A motor, especially an internal combustion engine, is used as the first machine in such a case, and such an engine may be a diesel engine, a gasoline engine or a gas engine. It is likewise conceivable to use a turbine for driving a vehicle.

In a special variant of the present invention, the powertrain of a vehicle is configured such that the internal combustion engine or the turbine runs preferably in a range that is optimal in terms of energy, while the speed adjustment of the drive shaft of the vehicle is carried out at least partially via the permanently excited synchronous machine coupled to the internal gear of the drive shaft of the vehicle. When the vehicle is stopped, the electrical energy storage devices located in the vehicle are charged by the synchronous machine, whose rotor is formed by the internal gear of the planetary gearbox or by the planetary gearbox housing connected to the internal gear.

In addition to an electromechanical system for transferring rotational energy, the present invention also pertains to a superimposed gearing with a planetary gearbox and with devices for dividing a torque introduced into the planetary gearbox in a specific manner. The planetary gearbox has a centrally arranged sun gear and at least one planetary gear meshing with the sun gear, of which the sun gear is connected to a first shaft for transferring a torque and the at least one planetary gear is connected to a second shaft for transferring a torque. Further, the planetary gearbox has a rotatably mounted internal gear, into which the devices for dividing the torque introduced into the planetary gearbox in a specific manner as a function of a control signal, which is preferably generated on the basis of a current operating situation by a drive electronic system, introduce a braking or accelerating force. The devices for dividing a torque introduced into the planetary gearbox in a specific manner have a synchronous machine, whose rotor is formed by the internal gear or by a component connected to the internal gear. The superimposed gearing configured according to the present invention is characterized in that the internal gear is connected to a housing of the planetary gearbox, at which permanent magnets are arranged. The synchronous machine is preferably excited by permanent magnets, which are indirectly or directly connected to the internal gear. In particular, the internal gear may be connected to a housing of the planetary gearbox, to which the permanent magnets are fastened. The permanent magnets may be attached to the housing of the planetary gearbox and/or to the outer wall of the internal gear or be embedded therein.

The electromechanical system configured according to the present invention for transferring rotational energy, torque and power as well as a superimposed gearing suitable for embodying a powertrain to be operated in a variable-speed manner are characterized in that the internal gear is connected to a housing of the planetary gearbox, and that permanent magnets are arranged at the internal gear and/or at the housing of the planetary gearbox for exciting the three-phase synchronous machine. The internal gear and/or the housing of the planetary gearbox form the rotor of a synchronous machine. It is preferably a permanently excited synchronous machine, wherein the permanent magnets are fastened especially to the internal gear and/or to the housing of the planetary gearbox, which housing is connected to the internal gear. Powers are introduced into or removed from the powertrain by the synchronous machine as a function of different loading conditions by a suitable actuation of the synchronous machine as a function of operating parameters, e.g., the speed of a main drive shaft or main power take-off shaft of the planetary gearbox. If the synchronous machine takes up power from the powertrain, electrical energy is generated and fed into the connected power grid.

It is thus possible during the operation of a powertrain with a superimposed gearing according to the present invention that the power of the main powertrain and of the synchronous machine add up or are subtracted from one another. In case of subtraction, a part of the power transferred by the main powertrain or of the torque is taken up by the synchronous machine and removed, and an infinite regulation and hence an infinite speed adjustment starting from “0” speed in the motor direction or in the generator direction is possible based on the use of a suitable drive electronic system. Only a portion of the power is sent now via the drive electronic system, which leads to corresponding savings in the electronic system.

The present invention will be explained in more detail below on the basis of special embodiments with reference to the figures without limitation of the general inventive idea. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a powertrain of a wind energy plant; and

FIG. 2 is schematic view of a powertrain of a processing machine.

### DESCRIPTION OF PREFERRED EMBODIMENTS

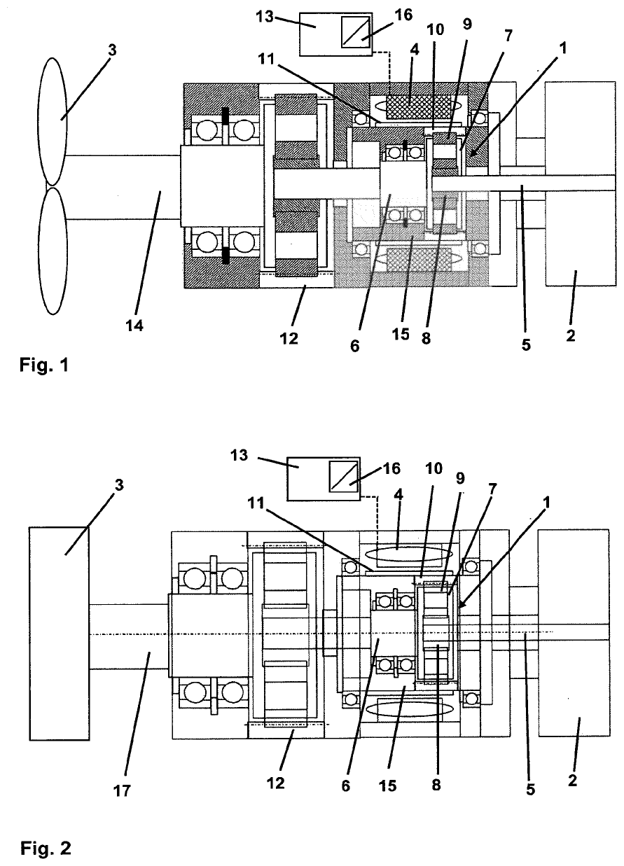

Referring to the drawings, FIG. 1 shows an electromechanical system configured according to the present invention for transferring rotational energy, torque and power, which is used as a powertrain of a wind energy plant. The system is configured, in particular, for the variable-speed transfer of rotational energy, torque and power. The first and second machines for energy conversion 2, 3, are an asynchronous generator 2 as well as a wind rotor 3 in this case, both of which are connected to one another via the main powertrain. The wind rotor 3 of the wind power plant is connected to the asynchronous generator 2 via a rotor power take-off shaft 14, a main gearing 12 and a superimposed gearing 1, which is connected in series therewith and is configured as a planetary gearbox 7. The asynchronous generator 2 is connected to the power grid and converts the power introduced by the wind rotor 3 into the powertrain into electrical energy. It is essential here that the wind rotor 3 and hence the rotor power take-off shaft 14 rotate at variable speed, while the speed of the generator shaft is at least nearly constant.

A synchronous generator may also be used instead of the asynchronous generator 2. The generator shaft must be synchronous in this case with the grid frequency based on the number of pole pairs.

The sun gear 8 of the planetary gearbox 7 is connected to the drive shaft 5 of the asynchronous generator 2. In addition, the planetary gears 9 circulating around the sun gear 8 are connected at least indirectly to the rotor power take-off shaft 14 and to the rotor 3 of the wind power plant via the carrier, the planet carrier 6 connected thereto and via the main gearings 12. The planetary gears 9 move, furthermore, the internal gear 10 of the planetary gearbox 7 or are driven by the internal gear 10. The internal gear 10 is connected, in turn, to the housing 15 of the planetary gearbox 7, and the internal gear 10 and the housing 15 are mounted rotatably.

Permanent magnets are fastened to the housing 15 of the planetary gearbox 7 as well as to the outer wall of the internal gear 10 such that the internal gear 10 with the housing 15 forms the rotor of a higher-poled, permanently excited synchronous machine, which is a third machine for energy conversion 4, and which machine 4 is coupled to the powertrain. The synchronous machine 4 is controlled by a drive electronic system 13 with a frequency converter 16 and is operated as a function of the operating situation such that power is transferred from the synchronous machine 4 to the internal gear 10 or is taken up from the internal gear 10 as needed. It is possible in this manner to introduce a braking torque or an acceleration torque into the internal gear 10 and hence into the powertrain connected to the planetary gearbox 7 as needed.

The asynchronous generator 2 is blocked at low wind speeds and hence low powers. The power generated by the wind rotor is introduced in this case into the synchronous machine 4 via the rotor power take-off shaft 14, the main gearing 12, the planet carrier 5, the planetary gears 9 and the internal gear 10, so that the synchronous machine is operated as a generator and the electrical energy generated is fed directly into the connected power grid via the drive electronic system 13. As soon as the speed of the wind rotor 3 has approximately reached the nominal speed of the generator shaft of the asynchronous generator 2, the brake of this generator is released and an additional rotation is generated at the generator shaft by the permanently excited synchronous machine 4 until the phase angle and the rotary frequency correspond to the values that are present in the connected grid and the generator 2 can be connected directly to the grid.

As soon as the asynchronous generator 2 was connected to the power grid, the permanently excited synchronous machine 4 is operated such that it holds only the housing 15 and the internal gear 10 of the planetary gearbox 7, which said internal gear 10 is connected thereto. The permanently excited synchronous machine 4 does not release power into the connected power grid in this operating state, nor does it take up power to a noteworthy extent from the power grid. The result of this is that the power of the powertrain can be fed over a broad range into the connected power grid by means of the asynchronous generator 2 operating at constant speed with a simultaneously sinusoidal voltage and current curve. It is, however, also possible to stop the permanently excited synchronous machine completely in this speed range of the plant when the internal gear 10 is stopped via a suitable braking device.

As the speed of rotation and hence the speed of the wind rotor 3 increase further, for example, because of wind gusts, the power provided hereby additionally in the powertrain is converted into electrical energy by the rotation of the internal gear 10 configured as the rotor of the synchronous machine 4, and this electrical energy is fed via the drive electronic system 13 into the connected grid. Furthermore, stronger wind gusts can be additionally compensated by adjusting the air gap torque of the permanently excited synchronous machine 4 shown in FIG. 1.

A special advantage of the electromechanical system with superimposed gearing 1, which system is shown on the basis of the powertrain of a wind power plant, is that wind gusts lead to an additional acceleration of the rotor of the synchronous machine 4 and hence to an increased power production, without the overall system being mechanically overloaded. The system characteristic explained is thus similar to that of wind power plants that are connected to twin-fed asynchronous generators, but it does avoid the drawbacks of the latter, such as the use of carbon brushes, which are subject to wear, as well as the lack of support of the connected power grid.

FIG. 2 shows the use of an electromechanical system configured according to the present invention with superimposed gearing 1 for transferring torque, rotational energy and power in a powertrain of a processing machine, as it is used, for example, in mining. The system is configured, in particular, for the variable-speed transfer of torque, rotational energy and power. The powertrain according to FIG. 2 has an asynchronous motor, which forms the first machine for energy conversion 2, which is connected directly to the power grid, as well as the processing machine, which is the second machine for energy conversion 3, which is coupled to the main powertrain, according to this configuration. If a corresponding powertrain is used in mining or in other areas with explosion hazard, all parts of the plant, especially the electric motors and generators used, are to be configured as explosion-proof or flameproof parts.

Compared to the powertrain explained in connection with FIG. 1, identical or at least similar components are used with the exception of the wind rotor, but the direction of the power flow in the powertrain is reversed, namely, from the asynchronous motor 2 via the motor power take-off shaft 5, the superimposed gearing 1 configured as a planetary gearbox 7, the planet carrier 6, an additional gear stage 12 and the drive shaft 17 of the processing machine 3 to the processing machine 3. The advantage of the embodiment shown is that the asynchronous machine 2 operating as a motor can be connected directly to the power grid. While the asynchronous machine 2 is switched to the grid, a low counter-torque is built up at the same time by the drive electronic system 13 in the air gap of the permanently excited synchronous machine, which is the third machine for energy conversion 4 coupled to the powertrain, so that the internal gear 10 configured as the rotor of the synchronous machine 4 is rotated and most of the power introduced by the asynchronous machine 2 into the powertrain is fed in the form of electrical energy into the connected power grid via the synchronous machine 4 and via the drive electronic system 13 thereof. The power released by the asynchronous motor 2 is fed now again nearly completely into the power grid via the synchronous machine 4 especially at the beginning of the start phase. Pulse-like overloads of the powertrain are avoided nearly completely due to a soft build-up of the counter-torque in the synchronous machine 4.

As soon as the asynchronous machine 2 and the processing machine 3 connected to this via the superimposed gearing 1 as well as via a stepup gearing 12 have reached the operating speed and the powertrain is thus in a quasi-stationary operation, the effect of an overload clutch can be achieved by setting a defined torque in the synchronous machine 4 with the superimposed gearing 1. An overload situation, for example, due to a blockage of the processing machine 3, would bring about an acceleration of the rotor of the synchronous machine 4 and feed again the additional power, which is present in the powertrain and is generated by the asynchronous machine 2, directly into the grid, without the other components of the powertrain being mechanically overloaded. Since only a portion of the power is sent via the drive electronic system 13, this drive electronic system 13 can be adapted corresponding to the power and manufactured in a comparatively cost-effective manner.

While specific embodiments of the invention have been shown and described in detail to illustrate the application of the principles of the invention, it will be understood that the invention may be embodied otherwise without departing from such principles.

1. An electromechanical system for transferring rotational energy, torque and power in a powertrain, the system comprising:
a first, a second and a third machine for energy conversion coupled to the powertrain, wherein the third machine is configured as a three-phase synchronous machine;
a superimposed gearing comprising a planetary gearbox comprising:
a planetary gearbox housing;
a sun gear coupled to the first machine via a first shaft for transferring a torque to the first machine;
at least one planetary gear coupled to the second machine via a second shaft for transferring a torque to the second machine; and
an internal gear that forms a rotor of the three-phase synchronous machine, wherein the internal gear is connected to the planetary gearbox housing; and
permanent magnets arranged at the internal gear and or at the planetary gearbox housing for exciting the three-phase synchronous machine.

2. An electromechanical system in accordance with claim 1, wherein the three-phase synchronous machine is configured as a permanent magnet-excited three-phase synchronous machine and the internal gear of the planetary gearbox is in functional connection with the permanent magnets for exciting the three-phase synchronous machine.

3. An electromechanical system in accordance with claim 1, further comprising a drive electronic system, wherein the three-phase synchronous machine is coupled to the drive electronic system for controlling the energy conversion, and the drive electronic system is configured such that the energy conversion takes place in the three-phase synchronous machine as a function of the energy converted by the first and or second machines.

4. An electromechanical system in accordance with claim 3, wherein the drive electronic system is configured such that the three-phase synchronous machine is operated at least at times in a four-quadrant operation.

5. An electromechanical system in accordance with claim 3, wherein the drive electronic system is configured such that an air gap torque of the three-phase synchronous machine is changed at least at times as a function of the energy converted by the first aid or second machines.

6. An electromechanical system in accordance with claim 1, further comprising at least one additional gearing is arranged between the planetary gearbox and the first and/or the second machine.

7. An electromechanical system in accordance with claim 6, wherein the planetary gearbox is arranged in a common oil chamber with the at least one additional gearing.

8. An electromechanical system in accordance with claim 1, wherein the first or the second machine is configured as a three-phase asynchronous machine connected to a power supply.

9. An electromechanical system in accordance with claim 1, wherein the first or the second machine is configured as an internal combustion engine, a turbo-engine, a wind rotor or a wind turbine.

10. A superimposed gearing comprising:
a planetary gearbox comprising:
a planetary gearbox housing;
a centrally arranged sun gear;
at least one planetary gear meshing with the sun gear;
a first shaft connected to the sun gear for transferring a torque;
a second shaft;
at least one planetary gear connected to the second shaft for transferring a torque; and
an internal gear of the planetary gearbox is mounted rotatably; and
devices for dividing, in a specific manner, torque introduced into the planetary gearbox as a function of a control signal, which is generated on the basis of a current operating situation by a drive electronic system, introduce a braking or acceleration torque into the internal gear, wherein the devices for dividing in a specific manner a torque introduced into the planetary gearbox comprises a three-phase synchronous machine wherein a rotor of the three-phase synchronous machine is formed by the internal gear or by a component connected to the internal gear, wherein the internal gear is connected to the planetary gearbox housing, at which permanent magnets are arranged.
